(19) United States
(12) Patent Application Publication
(10) Pub. No.: US 2015/0300424 A1
(43) Pub. Date: Oct. 22, 2015

(54) CLUTCH MECHANISM

(71) Applicant: DENSO CORPORATION, Aichi (JP)

(72) Inventors: Motohiko UEDA, Okazaki-city (JP); Yousuke YAMAGAMI, Obu-city (JP)

(21) Appl. No.: 14/443,028

(22) PCT Filed: Oct. 2, 2013
(86) PCT No.: PCT/JP2013/005864

§ 371 Date: May 14, 2015

(30) Foreign Application Priority Data
Nov. 16, 2012 (JP) 2012-252465

(51) Int. Cl. F16D 27/112; F16D 13/76; F16D 27/14; F16D 27/00

(52) U.S. Cl. CPC F16D 27/112; F16D 27/004; F16D 13/76; F16D 27/14; F16D 2027/008

(57) ABSTRACT

In a clutch mechanism, non-magnetic portions of an armature and non-magnetic portions of a pulley are offset from one another in a radial direction of a rotating shaft. For this reason, in an attracting magnetic circuit, magnetic flux passes between an outer cylindrical portion and an inner cylindrical portion so as to avoid the non-magnetic portions of the armature and the non-magnetic portions of the pulley. Accordingly, magnetic flux passes through a boundary between the armature and the pulley six times. The number of poles of the attracting magnetic circuit is increased. The physical size of a permanent magnet can be reduced. For this reason, the physical size of the clutch mechanism is reduced. As a result, the power consumption of an electromagnetic coil can be reduced by increasing the cross-sectional areas of coil portions. The physical size of the clutch mechanism is reduced and the power consumed is reduced.

### CROSS-REFERENCE TO RELATED APPLICATION

The present application is based on Japanese Patent Application No. 2012-252465 filed on Nov. 16, 2012, the content of which is incorporated herein by reference.

### TECHNICAL FIELD

The present disclosure relates to a clutch mechanism that uses a permanent magnet.

### BACKGROUND ART

As an electromagnet type clutch mechanism that is widely sold in the market at present, there is a clutch mechanism that includes a pulley rotated by a rotational drive force transmitted from an engine and an armature transmitting the rotational drive force to a compressor. Such a clutch mechanism is adapted not to use a permanent magnet and is adapted to generate magnetic attraction, which causes the pulley to be attracted to the armature, from an electromagnetic coil.

When the pulley and the armature are connected to each other in the clutch mechanism, the rotational drive force applied from the engine is transmitted to the compressor through the pulley and the armature. When the pulley and the armature are separated from each other, the transmission of the rotational drive force to the compressor from the engine is cut off. When the armature and the pulley are connected to each other in the clutch mechanism formed in this way, power needs to be continuously supplied to the electromagnetic coil so that magnetic attraction is generated from the electromagnetic coil.

In contrast, as a clutch mechanism that generates magnetic attraction by using a permanent magnet, there is a clutch mechanism that includes a pulley, an armature, an electromagnetic coil including first and second coil portions, a permanent magnet interposed between the first and second coil portions, and a movable member made of a magnetic material and movable in an axial direction of a rotating shaft of a compressor (see Patent Literature 1).

In such a clutch mechanism, the pulley, the armature, and the permanent magnet form an attracting magnetic circuit. A magnetic force generated from the attracting magnetic circuit acts as attraction that attracts the armature to the pulley. The permanent magnet forms a non-attracting magnetic circuit different from the attracting magnetic circuit. An elastic member, which applies an elastic force in a direction in which the armature and the pulley are separated from each other, is disposed.

When the pulley and the armature are connected to each other, the movable member is positioned at a position (hereinafter, referred to as a first position) where the magnetic resistance of the attracting magnetic circuit is smaller than the magnetic resistance of the attracting magnetic circuit that is obtained when the pulley and the armature are separated from each other.

When the pulley and the armature are separated from each other, the movable member is positioned at a position (hereinafter, referred to as a second position) where the magnetic resistance of the non-attracting magnetic circuit is smaller than the magnetic resistance of the non-attracting magnetic circuit that is obtained when the pulley and the armature are connected to each other.

Further, when a current is made to flow in the first and second coil portions in a first direction while the pulley and the armature are connected to each other, the magnetic force generated from the attracting magnetic circuit is reduced by an electromagnetic force generated from the first coil portion and a magnetic force generated from the non-attracting magnetic circuit is increased by an electromagnetic force generated from the second coil portion. Accordingly, the magnetic force generated from the non-attracting magnetic circuit becomes larger than the magnetic force generated from the attracting magnetic circuit. As a result, the movable member is moved to a side of the second position from a side of the first position by the magnetic force that is generated from the non-attracting magnetic circuit.

At this time, magnetic attraction generated from the attracting magnetic circuit becomes smaller than the elastic force of the elastic member. For this reason, a state in which the pulley and the armature are connected to each other is changed into a state in which the pulley and the armature are separated from each other by the elastic force of the elastic member. That is, the state of the clutch mechanism is switched to an OFF state from an ON state.

Next, when current is made to flow in the first and second coil portions in a direction opposite to the first direction while the pulley and the armature are separated from each other, the magnetic force generated from the attracting magnetic circuit is increased by the electromagnetic force generated from the first coil portion and the magnetic force generated from the non-attracting magnetic circuit is reduced by the electromagnetic force generated from the second coil portion. Accordingly, the magnetic force generated from the attracting magnetic circuit becomes larger than the magnetic force generated from the non-attracting magnetic circuit. As a result, the movable member is moved to the side of the first position from the side of the second position by the magnetic force that is generated from the attracting magnetic circuit.

At this time, magnetic attraction generated from the attracting magnetic circuit becomes larger than the elastic force of the elastic member. For this reason, a state in which the pulley and the armature are separated from each other is changed into a state in which the pulley and the armature are connected to each other by the magnetic attraction generated from the attracting magnetic circuit. That is, the state of the clutch mechanism is switched to an ON state from an OFF state.

A current is made to flow in the first and second coil portions only when the state in which the pulley and the armature are connected to each other is changed into the state in which the pulley and the armature are separated from each other or when the state in which the pulley and the armature are separated from each other is changed into the state in which the pulley and the armature are connected to each other as described above. For this reason, significant power saving can be achieved in comparison with the electromagnet type clutch mechanism in the related art.

### PRIOR ART LITERATURE

### Patent Literature

Patent Literature 1: JP 2011-080579 A

### SUMMARY OF THE INVENTION

The inventor and the like found the following problems through detailed magnetic field analysis of the clutch mechanism of Patent Literature 1 while focusing on a reduction in size.

First, the electromagnet type clutch mechanism is adapted to generate attraction, which maintains a state in which the armature and the pulley are connected to each other, from the electromagnetic coil. However, the clutch mechanism of Patent Literature 1 is adapted to generate the attraction by using the permanent magnet. For this reason, there is a concern that a permanent magnet having a large physical size may be required in the clutch mechanism of Patent Literature 1 in order to obtain the same transmission torque as the electromagnet type clutch mechanism. Accordingly, the dimension of the clutch mechanism itself in the axial direction (the axial length of the clutch mechanism) tends to increase in the structure of Patent Literature 1.

In addition, when a permanent magnet having a large physical size is used, the amount of magnetic flux flowing in the non-attracting magnetic circuit is also increased. For this reason, there is a practical problem in that a large amount of power, though momentarily, needs to be supplied to the first and second coil portions to move the movable member.

For example, FIG. 10 shows a design example of the electromagnet type electromagnetic clutch, and shows an example in which a distance between a contact surface Ha of a stator 56 to be mounted on a compressor and an end face of an armature 40 is 36 mm and the nominal diameter φ of a pulley 40 is 115 mm.

When magnetic field analysis is performed in such an example and a magnetomotive force applied to an electromagnetic coil 53A is set to 700 AT (ampere turn=current×the number of turns), the attraction of the armature 40 to a pulley (rotor) 30 is 4300 N. Further, power consumption of 30 W is required to generate a magnetomotive force of 700 AT in the physical size of the electromagnetic coil 53A of FIG. 10.

FIG. 11 shows an example that is designed so that an attraction of 4300 N is generated in a self-holding type clutch mechanism that includes a friction surface (a contact surface between the pulley 30 and the armature 40) having the same size as that of FIG. 10 and follows an idea of the aforementioned invention of Patent Literature 1. In this case, even though a neodymium magnet (the maximum energy product: 40 MGOe) of which a magnetic force is large is used, the amount of the permanent magnet to be used is 92 g (an inner diameter φ of 73.4 mm, an outer diameter φ of 82.2 mm, and an axial length of 11.25 mm).

When the clutch mechanism is in an OFF state, the leakage of magnetic flux to an attracting magnetic circuit MCa from a non-attracting magnetic circuit MCb needs to be prevented in the self-holding type clutch mechanism. For this reason, the thicknesses of a moveable member 9, a cylindrical portion 56a of the stator 56, and the wall portion 56b of the stator 56, which form the non-attracting magnetic circuit MCb, need to be set to a thickness that does not allow magnetic saturation to occur.

Here, the electromagnet type electromagnetic clutch of FIG. 10 originally has a structure that does not include the non-attracting magnetic circuit MCb. For this reason, the thicknesses of the cylindrical portion 56a and the wall portion 56b of the stator 56 and the movable member 55 of the self-holding type clutch mechanism of FIG. 11 need to be set to be larger than the thicknesses of the inner cylindrical portion 56c, the wall portion 56b, and the outer peripheral cylindrical portion 56d of the stator 56 of the electromagnet type electromagnetic clutch of FIG. 10.

For the above-mentioned reason, there is a problem in that the same attraction, that is, the same transmission torque cannot be obtained in the self-holding type clutch mechanism without an increase in the physical size and the weight in comparison with the electromagnet type electromagnetic clutch.

In addition, according to the inventor's consideration, it has been made apparent from magnetic field analysis that a magnetomotive force of 700 AT needs to be applied to each of first and second coil portions 53a and 53b to change the state of the clutch mechanism into an ON state from an OFF state.

However, as apparent from the comparison between FIGS. 11 and 10, the physical size of the electromagnetic coil 53 of FIG. 11 is smaller than the physical size of the electromagnetic coil 53A of FIG. 10. For example, a ratio (=(Sa/Sb)×100%) of a cross-sectional area Sa of the electromagnetic coil 53a (or 53b) of FIG. 11 to a cross-sectional area Sb of the electromagnetic coil 53A of FIG. 10 is about 25%.

Here, in order to generate a constant magnetomotive force from the electromagnetic coil 53, the diameter of the coil wire forming the electromagnetic coil 53 needs to be increased and the number of turns of the coil wire needs to be reduced as the cross-sectional area of the electromagnetic coil 53 is reduced. Since the resistance value per unit cross-sectional area is reduced as the diameter of the coil wire is increased, current flowing in the coil wire is increased. For this reason, as the cross-sectional area of the electromagnetic coil 53 is reduced, power consumed by the electromagnetic coil 53 is increased.

For example, the electromagnetic coil 53A of FIG. 10 generates a magnetomotive force of 700 AT with power consumption of 30 W, and the power consumption of each of the first and second coil portions 53a and 53b of FIG. 11 is 120 W. There is a concern that the capacity of various electronic components, such as a harness and a connector, needs to be increased to supply power of 120 W to the first and second coil portions 53a and 53b even though power is supplied for a short time (for example, about 0.2 sec.).

The present disclosure has been made in consideration of the above-mentioned circumstances, and an object of the present disclosure is to provide a clutch mechanism of which the physical size can be reduced with a small amount of a permanent magnet to be used and of which the power consumption of an electromagnetic coil can also be reduced.

A first example of the present disclosure includes a driving-side rotating body that is rotated by a rotational drive force from a drive source, a driven-side rotating body, to which the rotational drive force is transmitted, that is connected to the driving-side rotating body, a permanent magnet that forms, together with the driving-side rotating body and the driven-side rotating body, an attracting magnetic circuit which generates magnetic attraction that causes the driving-side rotating body and the driven-side rotating body to be connected to each other, the permanent magnet forming a non-attracting magnetic circuit different from the attracting magnetic circuit, an electromagnetic coil that generates an electromagnetic force that changes a magnetic force generated from the attracting magnetic circuit and a magnetic force generated from the non-attracting magnetic circuit, a movable member that is made of a magnetic material and is displaceable, the movable member positioning at a first position where a magnetic resistance of the attracting magnetic circuit is smaller when the driving-side rotating body and the driven-side rotating body are connected to each other than when the driving-side rotating body and the driven-side rotating body are separated from each other, the movable member positioning at a second position where the magnetic resistance of the non-attracting magnetic circuit is smaller when the driving-side rotating body and the driven-side rotating body are separated from each other than when the driving-side rotating body and the driven-side rotating body are connected from each other, a first control unit that displaces the movable member, to a side of the first position from a side of the second position using the magnetic force generated from the attracting magnetic circuit, by supplying power to the electromagnetic coil so that the magnetic force generated from the attracting magnetic circuit is larger than the magnetic force generated from the non-attracting magnetic circuit, and a second control unit that displaces the movable member, to the side of the second position from the side of the first position using the magnetic force generated from the non-attracting magnetic circuit, by supplying power to the electromagnetic coil so that the magnetic force generated from the non-attracting magnetic circuit is larger than the magnetic force generated from the attracting magnetic circuit, wherein a number of poles is defined as a number of times a magnetic flux flowing through the attracting magnetic circuit passes through a boundary between the driving-side rotating body and the driven-side rotating body, and the driving-side rotating body and the driven-side rotating body are configured so that the number of poles of the attracting magnetic circuit is six or more.

Here, if the number of poles is large when the magnetic attraction is to be generated, the magnetic flux flowing in the attracting magnetic circuit is reduced. Accordingly, the amount of the permanent magnet to be used is reduced. That is, the physical size of the permanent magnet can be reduced. For this reason, the dimension of the clutch mechanism in the axial direction can be reduced and the cross-sectional area of the electromagnetic coil can be increased.

In order to generate a constant magnetomotive force from the electromagnetic coil, the diameter of the coil wire forming the electromagnetic coil can be reduced and the number of turns of the coil wire can be increased as the cross-sectional area of the electromagnetic coil is increased.

Further, since the resistance value of the coil wire per unit cross-sectional area is increased as the diameter of the coil wire is reduced, a current flowing in the electromagnetic coil is reduced. For this reason, the power consumption of the electromagnetic coil can be reduced. Accordingly, as the cross-sectional area of the electromagnetic coil is increased, the power consumption of the electromagnetic coil is reduced.

In addition, since the amount of magnetic flux flowing in the attracting magnetic circuit is reduced, the magnetomotive force of the electromagnetic coil, which is necessary to change the state of the clutch mechanism into an ON state from an OFF state, can also be reduced.

Here, the power consumption of the electromagnetic coil, which is necessary to change the state of the clutch mechanism to an ON state from an OFF state, is proportional to the square of the magnetomotive force of the electromagnetic coil. For this reason, as the magnetomotive force is reduced, the power consumption of the electromagnetic coil can be reduced.

When the cross-sectional area of the electromagnetic coil is increased and a magnetomotive force is also reduced as described above, the power consumption of the electromagnetic coil can be significantly reduced. Accordingly, while the same transmission torque as that in the related art is achieved with a small amount of the permanent magnet to be used, the physical size of the clutch mechanism can be reduced and the power consumption of the electromagnetic coil can also be reduced.

Meanwhile, the OFF state of the clutch mechanism is a state in which the driving-side rotating body and the driven-side rotating body are separated from each other. The ON state of the clutch mechanism is a state in which the driving-side rotating body and the driven-side rotating body are connected to each other.

### BRIEF DESCRIPTION OF THE DRAWINGS

FIG. 1 is a view showing the entire configuration of a refrigeration cycle device of a first embodiment to which a clutch structure of the present disclosure is applied.

FIG. 2 is a cross-sectional view of the clutch structure of the first embodiment.

FIG. 3 is a cross-sectional view taken along line III-III of FIG. 2.

FIG. 4 is a view showing only a pulley of FIG. 2 that is seen from a compressor.

FIG. 5 is a view showing only an armature of FIG. 2 that is seen from the pulley.

FIG. 6(a) is a partial enlarged view showing a state in which the pulley and the armature are connected to each other, FIG. 6(b) is a partial enlarged view illustrating an operation for separating the pulley from the armature, FIG. 6(c) is a partial enlarged view showing a state in which the pulley and the armature are separated from each other, and FIG. 6(d) is a partial enlarged view illustrating an operation for connecting the pulley to the armature.

FIG. 7 is a table showing a relationship among the number of poles, magnetic flux, and a pole area of an attracting magnetic circuit.

FIG. 8 is a view showing an example of the dimensions of the clutch structure of the first embodiment.

FIG. 9 is a partial cross-sectional view of a clutch structure of a second embodiment of the present disclosure.

FIG. 10 is a view showing a clutch structure of a first comparative example of the present disclosure.

FIG. 11 is a view showing a clutch structure of a second comparative example of the present disclosure.

### EMBODIMENTS FOR CARRYING OUT THE INVENTION

Embodiments of the present disclosure will be described below with reference to the drawings. Portions of each embodiment corresponding to items, which have been described in the previous embodiments, may be denoted by the same reference numerals and the repeated description thereof may be omitted in each embodiment. When only a part of the structure of each embodiment is described, the other embodiments having been previously described can be applied to the other part of the structure. Portions, of which the possibility of the combination has been specifically described clearly in each embodiment, can be combined with each other, and embodiments can also be partially combined with each other if a problem does not particularly occur in combination even though the combination is not described clearly.

### First Embodiment

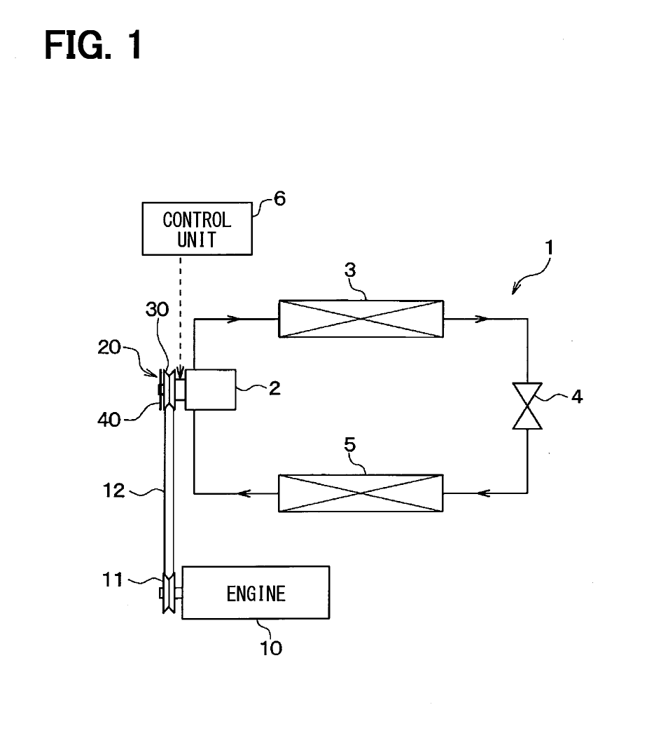

FIG. 1 is a view showing the entire configuration of a refrigeration cycle device 1 of a vehicle air conditioning apparatus to which a clutch mechanism 20 of this embodiment is applied.

The refrigeration cycle device 1 includes a compressor 2, a radiator 3, an expansion valve 4, and an evaporator 5 that are connected to each other. The compressor 2 sucks a refrigerant and compresses the refrigerant. The radiator 3 allows the refrigerant, which is discharged from the compressor 2, to radiate heat. The expansion valve 4 depressurizes and expands the refrigerant that flows out of the radiator 3. The evaporator 5 exhibits a heat absorbing action by evaporating the refrigerant that has been depressurized by the expansion valve 4.

The compressor 2 is installed in an engine room of a vehicle. The compressor 2 drives a compression mechanism by a rotational drive force, which is applied from an engine 10 as a propulsion drive source through the clutch mechanism 20, to suck a refrigerant from the evaporator 5 and compress the refrigerant.

Meanwhile, any one of a fixed-capacity compression mechanism of which the discharge capacity is fixed and a variable-capacity compression mechanism of which the discharge capacity can be adjusted by a control signal input from the outside may be employed as the compression mechanism.

The clutch mechanism 20 of this embodiment is a clutch mechanism that is connected to the compressor 2 and is integrated with a pulley. The clutch mechanism 20 transmits the rotational drive force of the engine 10, which is applied from an engine-side pulley 11 through a V-belt 12, to the compressor 2. The engine-side pulley 11 is connected to a rotation drive shaft of the engine 10.

The clutch mechanism 20 includes a pulley 30 and an armature 40. The pulley 30 forms a driving-side rotating body that is rotated by the rotational drive force applied from the engine 10 through the V-belt 12. The armature 40 forms a driven-side rotating body that is connected to a rotating shaft 2a of the compressor 2. The clutch mechanism 20 intermittently transmits a rotational drive force from the engine 10 to the compressor 2 by connecting the pulley 30 to the armature 40 or separating the pulley 30 from the armature 40.

That is, when the clutch mechanism 20 connects the pulley 30 to the armature 40, the rotational drive force of the engine 10 is transmitted to the compressor 2. Accordingly, the refrigeration cycle device 1 operates. Meanwhile, when the clutch mechanism 20 separates the pulley 30 from the armature 40, the rotational drive force of the engine 10 is not transmitted to the compressor 2. Accordingly, the refrigeration cycle device 1 does not operate.

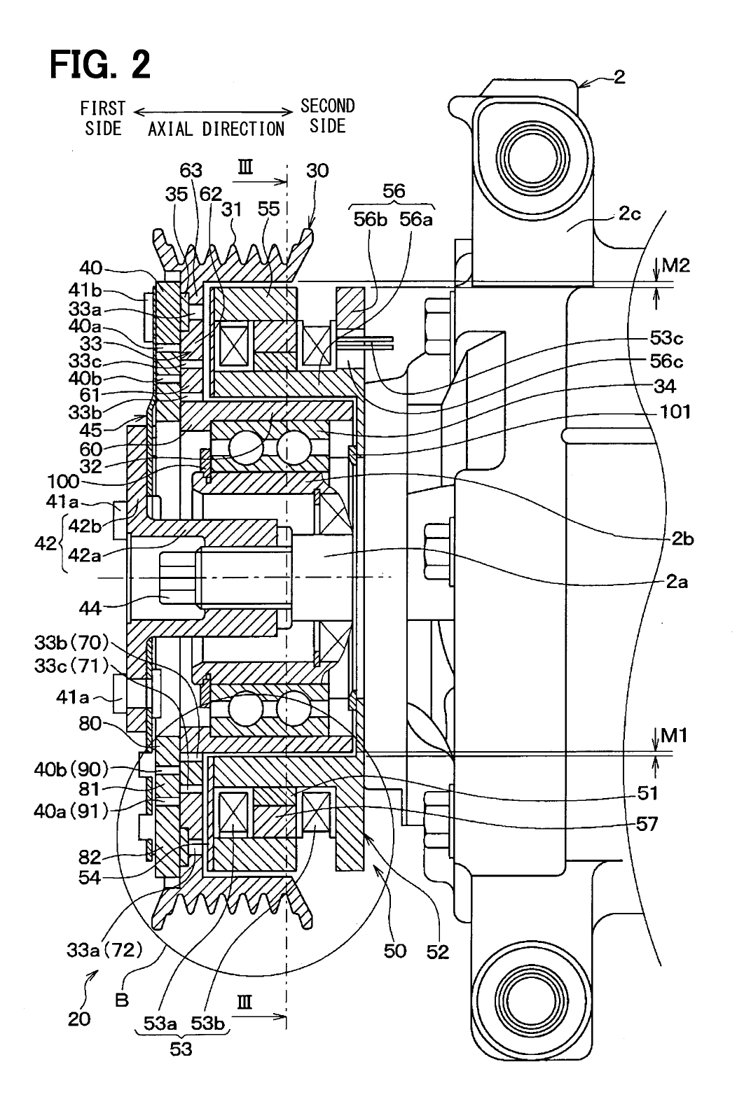

Next, the detailed structure of the clutch mechanism 20 of this embodiment will be described with reference to FIGS. 2, 3, and 4. Meanwhile, in the following description, one side (the left side in FIG. 2) of the clutch mechanism 20 in an axial direction (a rotation axis direction) may be referred to as a first side and the other side (the right side in FIG. 2) thereof may be referred to as a second side.

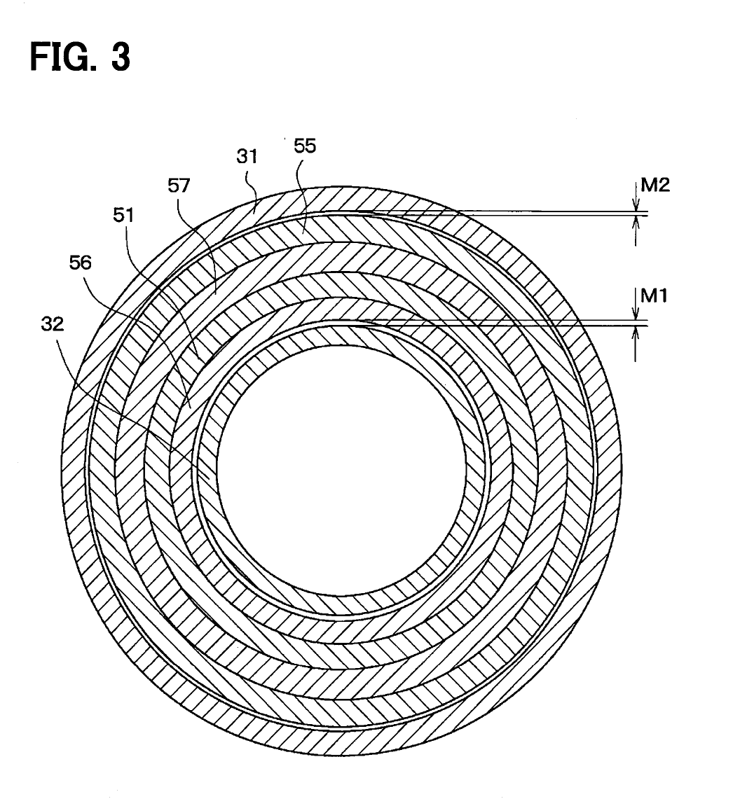

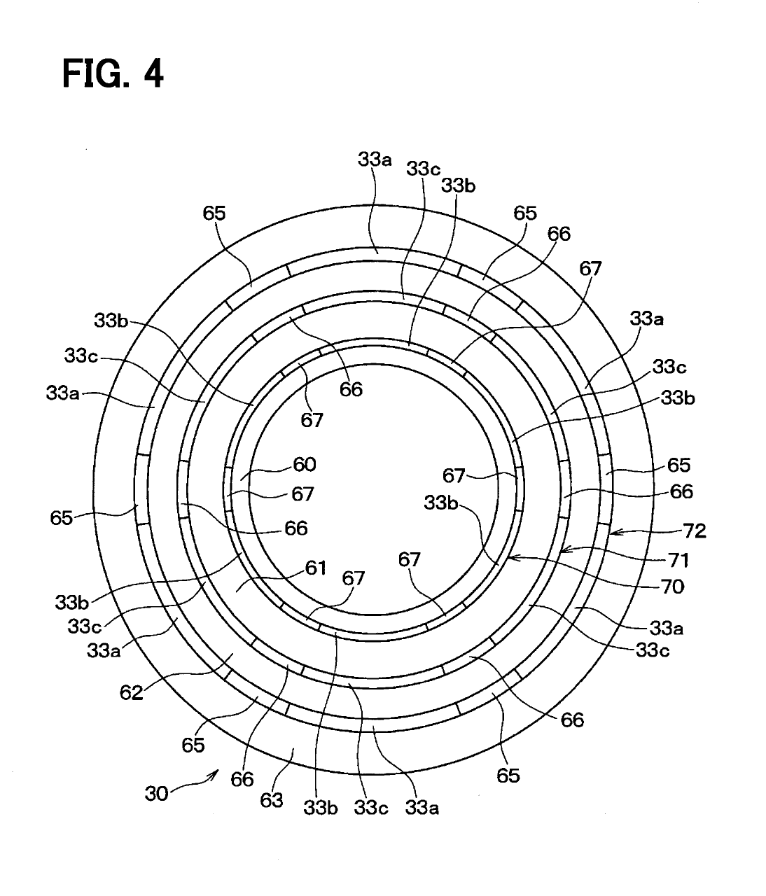

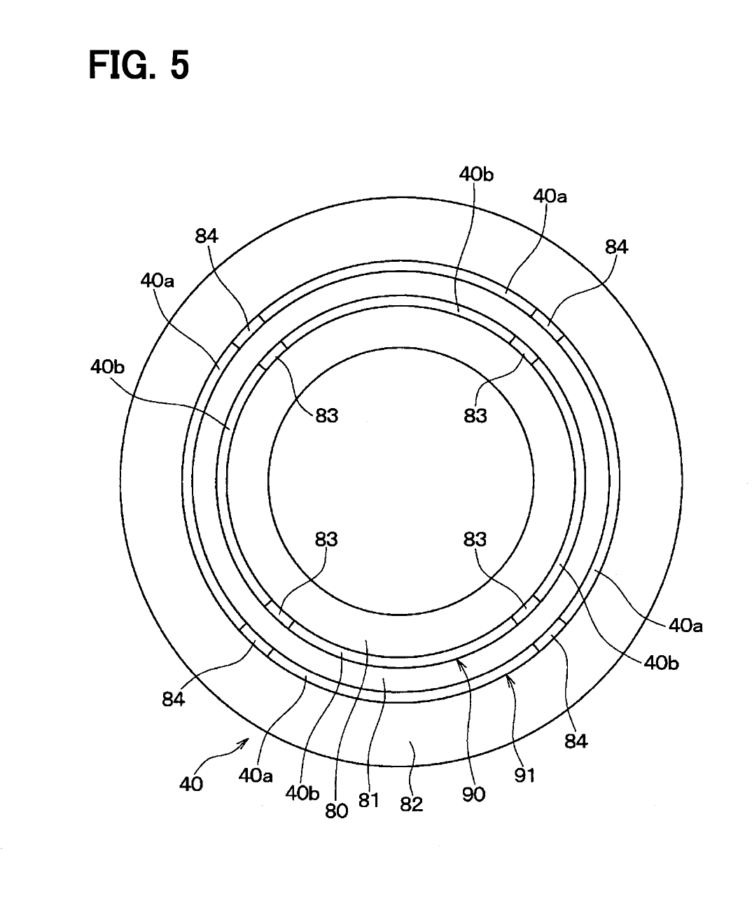

FIG. 2 is an axial cross-sectional view of the clutch mechanism 20. The axial cross-sectional view is a cross-sectional view of the clutch mechanism 20 that includes an axis of the rotating shaft 2a of the compressor 2 and is along the axis. FIG. 3 is a cross-sectional view taken along line III-III of FIG. 2. FIG. 2 shows a state in which the pulley 30 and the armature 40 are connected to each other. A hub 42 to be described below is not shown in FIG. 3. FIG. 4 is a view showing only the pulley 30 that is seen from the second side in the axial direction of the rotating shaft 2a of the compressor 2, and FIG. 5 is a view showing only the armature 40 that is seen from the second side in the axial direction.

As shown in FIGS. 2 and 3, the clutch mechanism 20 includes a stator 50 in addition to the pulley 30 and the armature 40.

First, the pulley 30 includes an outer cylindrical portion 31, an inner cylindrical portion 32, and an end face portion 33.

The outer cylindrical portion 31 is formed in the shape of a cylinder that has a center line on the axis of the rotating shaft 2a of the compressor 2 (one-dot chain line in FIG. 2). The outer cylindrical portion 31 is made of a magnetic material (for example, iron). V grooves (specifically, poly V-grooves) on which the V-belt 12 is wound are formed on the outer peripheral of the outer cylindrical portion 31.

The inner cylindrical portion 32 is disposed on the inner peripheral side of the outer cylindrical portion 31 and is formed in the shape of a cylinder that has an axis on the axis of the rotating shaft 2a of the compressor 2. The inner cylindrical portion 32 is integrally made of a magnetic material (for example, iron).

An outer race of a ball bearing 34 is fixed to the inner peripheral of the inner cylindrical portion 32. The ball bearing 34 fixes the pulley 30 to a housing 2c, which forms the outer shell of the compressor 2, so as to allow the pulley 30 to be rotatable about the axis of the rotating shaft 2a as a center line. For this purpose, an inner race of the ball bearing 34 is fixed to the housing 2c of the compressor 2 by a fixing member such as a snap ring 100. The inner race of the ball bearing 34 is disposed outside a housing boss 2b, which is formed on the housing 2c of the compressor 2, in a radial direction. The housing boss 2b is formed in the shape of a cylinder that has a center line on the axis of the rotating shaft 2a of the compressor 2.

The end face portion 33 is formed between an end portion of the outer cylindrical portion 31 that corresponds to the first side in the rotation axis direction and an end portion of the inner cylindrical portion 32 that corresponds to the first side in the rotation axis direction.

The end face portion 33 is formed in the shape of a ring that has a center on the axis of the rotating shaft 2a. Specifically, the end face portion 33 includes ring members 60, 61, 62, and 63 as shown in FIG. 4.

The ring members 60, 61, 62, and 63 are formed in the shape of a ring that has a center on the axis of the rotating shaft 2a. The ring members 60, 61, 62, and 63 are disposed so as to be offset from one another in the radial direction of the rotating shaft 2a.

The ring member 60 of this embodiment is disposed on the inner peripheral side of the ring member 61. The ring member 61 is disposed on the inner peripheral side of the ring member 62. The ring member 62 is disposed on the inner peripheral side of the ring member 63. Further, each of the ring members 60, 61, 62, and 63 is made of a magnetic material (for example, iron).

Six bridge members 67, which connect the ring member 60 to the ring member 61, are provided between the ring members 60 and 61. The six bridge members 67 are made of a non-magnetic metal material, and are disposed around the axis of the rotating shaft 2a so as to be offset from one another by an angle of 60°.

Accordingly, six arc-shaped gaps 33b, which have a center on the axis of the rotating shaft 2a, are formed between the ring members 60 and 61. That is, a non-magnetic portion 70 (a driving-side non-magnetic portion), which is formed of the six gaps 33b and the six bridge members 67, is formed between the ring members 60 and 61. The non-magnetic portion 70 is formed in the shape of a ring that has a center on the axis of the rotating shaft 2a.

Six bridge members 66, which connect the ring member 61 to the ring member 62, are provided between the ring members 61 and 62. The six bridge members 66 are made of a non-magnetic metal material, and are disposed around the axis of the rotating shaft 2a so as to be offset from one another by an angle of 60°.

Accordingly, six arc-shaped gaps 33c, which have a center on the axis of the rotating shaft 2a, are formed between the ring members 61 and 62. That is, a non-magnetic portion 71 (a driving-side non-magnetic portion), which is formed of the six gaps 33c and the six bridge members 66, is formed between the ring members 61 and 62. The non-magnetic portion 71 is formed in the shape of a ring that has a center on the axis of the rotating shaft 2a.

Six bridge members 65, which connect the ring member 62 to the ring member 63, are provided between the ring members 62 and 63. The six bridge members 65 are made of a non-magnetic metal material, and are disposed around the axis of the rotating shaft 2a so as to be offset from one another by an angle of 60°.

Accordingly, six arc-shaped gaps 33a, which have a center on the axis of the rotating shaft 2a, are formed between the ring members 62 and 63. That is, a non-magnetic portion 72 (a driving-side non-magnetic portion), which is formed of the six gaps 33b and the six bridge members 65, is formed between the ring members 62 and 63. The non-magnetic portion 72 is formed in the shape of a ring that has a center on the axis of the rotating shaft 2a.

The pulley 30 is integrally formed in this embodiment. For this reason, the outer cylindrical portion 31 and the ring member 63 of the end face portion 33 are connected to each other. The ring member 60 of the end face portion 33 and the inner cylindrical portion 32 are connected to each other. Further, the outer cylindrical portion 31, the ring members 60, 61, 62, and 63 of the end face portion 33, and the inner cylindrical portion 32 form an attracting magnetic circuit MCa as described below.

Furthermore, the surface of the end face portion 33, which corresponds to the first side, forms a friction surface that comes into contact with the armature 40 when the pulley 30 and the armature 40 are connected to each other. Moreover, in this embodiment, a friction member, which increases the coefficient of friction of the end face portion 33, is disposed on the surface of the non-magnetic portion 72 (the gaps 33a) of the end face portion 33. The friction member is formed in the shape of a ring that has a center on the axis of the rotating shaft 2a. The friction member is made of a non-magnetic material. Specifically, a material, which is obtained by solidifying alumina with a resin, or a sintered material of metal powder (for example, aluminum powder) can be employed for the friction member.

The armature 40 is disposed on the first side of the end face portion 33 of the pulley 30 in the axial direction. The armature 40 forms the attracting magnetic circuit MCa as described below. Specifically, the armature 40 is a disc-shaped member that is spread in a direction perpendicular to the rotating shaft 2a and includes a through hole formed at the central portion which penetrates both surfaces thereof. The center of rotation of the armature 40 corresponds to the axis of the rotating shaft 2a.

As shown in FIG. 5, the armature 40 includes ring members 80, 81, and 82. The ring members 80, 81, and 82 are formed in the shape of a ring that has a center on the axis of the rotating shaft 2a. The ring members 80, 81, and 82 are disposed so as to be offset from one another in the radial direction of the rotating shaft 2a.

The ring member 80 of this embodiment is disposed on the inner peripheral side of the ring member 81. The ring member 81 is disposed on the inner peripheral side of the ring member 82. Further, each of the ring members 80, 81, and 82 is made of a magnetic material (for example, iron).

Four bridge members 83, which connect the ring member 80 to the ring member 81, are provided between the ring members 80 and 81. The four bridge members 83 are made of a non-magnetic metal material, and are disposed around the axis of the rotating shaft 2a so as to be offset from one another by an angle of 45°.

Accordingly, four arc-shaped gaps 40b, which have a center on the axis of the rotating shaft 2a, are formed between the ring members 80 and 81. That is, a non-magnetic portion 90 (a driven-side non-magnetic portion), which is formed of the four gaps 40b and the four bridge members 83, is formed between the ring members 80 and 81. The non-magnetic portion 90 is formed in the shape of a ring that has a center on the axis of the rotating shaft 2a.

Four bridge members 84, which connect the ring member 81 to the ring member 82, are provided between the ring members 81 and 82. The four bridge members 84 are made of a non-magnetic metal material, and are disposed around the axis of the rotating shaft 2a so as to be offset from one another by an angle of 45°.

Accordingly, four arc-shaped gaps 40a, which have a center on the axis of the rotating shaft 2a, are formed between the ring members 81 and 82. That is, a non-magnetic portion 91 (a driven-side non-magnetic portion), which is formed of the four gaps 40a and the four bridge members 84, is formed between the ring members 81 and 82. The non-magnetic portion 91 is formed in the shape of a ring that has a center on the axis of the rotating shaft 2a.

The non-magnetic portions 90 and 91 of the armature 40 and the non-magnetic portions 70, 71, and 72 of the pulley 30, which are formed as described above, are offset from one another in the radial direction of the rotating shaft 2a. Specifically, the non-magnetic portion 90 of the armature 40 is disposed between the non-magnetic portions 70 and 71 of the pulley 30. The non-magnetic portion 91 of the armature 40 is disposed between the non-magnetic portions 71 and 72 of the pulley 30.

Here, the flat surface of the armature 40, which corresponds to the second side, faces the end face portion 33 of the pulley 30. That is, the end face portion 33 is disposed on the second side of the non-magnetic portions 90 and 91 so as to face the non-magnetic portions 90 and 91. The flat surface of the armature 40, which corresponds to the second side, forms a friction surface that comes into contact with the pulley 30 when the pulley 30 and the armature 40 are connected to each other. A disc-shaped hub 42 is disposed on the first side of the armature 40.

The hub 42 forms a connecting member that connects the armature 40 to the rotating shaft 2a of the compressor 2. Specifically, the hub 42 includes a cylindrical portion 42a that extends in the rotation axis direction and a flange portion 42b that spreads from the first side of the cylindrical portion 42a in a direction perpendicular to the rotating shaft.

A leaf spring 45, which spreads in the direction perpendicular to the rotating shaft, is disposed between the hub 42 and the armature 40. The leaf spring 45 is fixed to the flange portion 42b of the hub 42 by a rivet 41a.

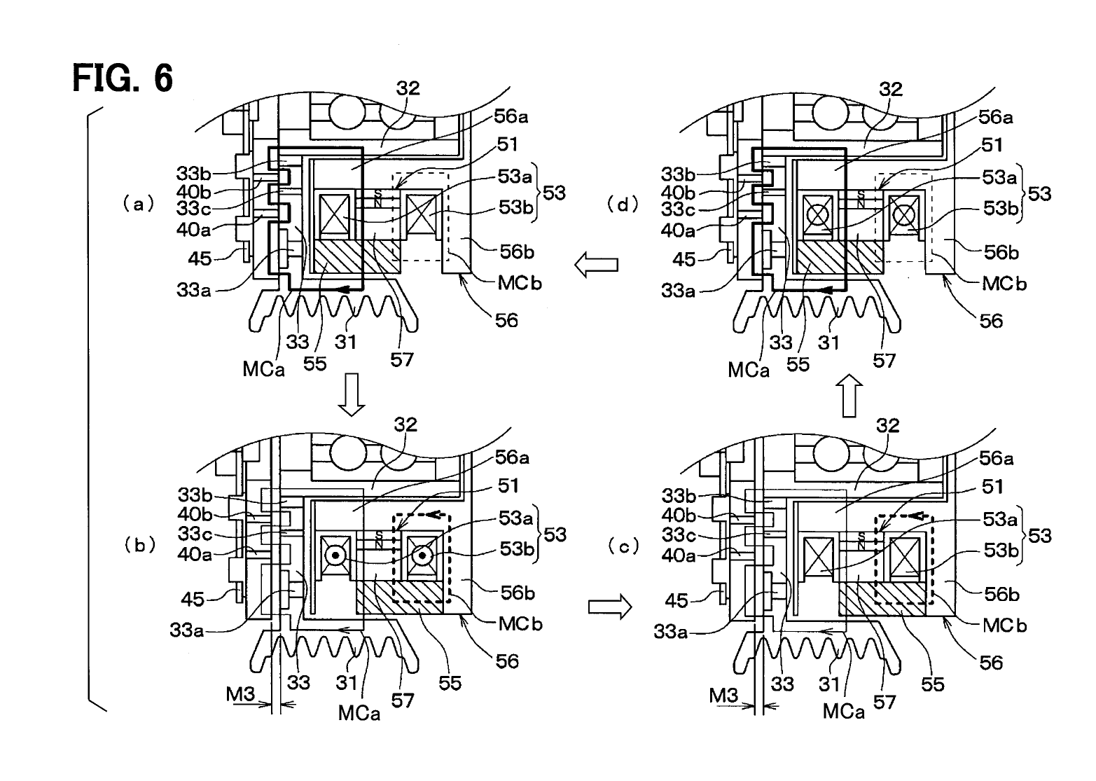

Here, the leaf spring 45 is fixed to the armature 40 by a rivet 41b. The leaf spring 45 applies an elastic force to the hub 42 in a direction in which the armature 40 is separated from the pulley 30. When the pulley 30 and the armature 40 are separated from each other, a predetermined clearance M3 (see FIG. 6 to be described below) is formed between the armature 40 connected to the hub 42 and the end face portion 33 of the pulley 30 by the elastic force.

The cylindrical portion 42a is fastened to the rotating shaft 2a of the compressor 2 by a bolt 44, so that the hub 42 is fixed. Meanwhile, fasteners, such as splines (serrations) or keyways, may be used to fix the hub 42 to the rotating shaft 2a of the compressor 2.

Accordingly, the armature 40, the hub 42, the leaf spring 45, and the rotating shaft 2a of the compressor 2 are connected. Further, when the pulley 30 and the armature 40 are connected to each other, the armature 40, the hub 42, the leaf spring 45, and the rotating shaft 2a of the compressor 2 rotate together with the pulley 30.

Furthermore, the stator 50 is a stator assembly that includes a permanent magnet 51, an electromagnetic coil 53, a stopper portion 54, a movable member 55, a stator housing 56, and a yoke 57.

The permanent magnet 51 is formed in an annular shape that has a center on the axis of the rotating shaft 2a of the compressor 2. An outer peripheral portion of the permanent magnet 51 forms an N pole, and an inner peripheral portion of the permanent magnet 51 forms an S pole. The permanent magnet 51 forms the attracting magnetic circuit MCa and a non-attracting magnetic circuit MCb as described below.

In this embodiment, neodymium or samarium cobalt can be employed as a material of the permanent magnet 51. Further, the permanent magnet 51, the electromagnetic coil 53, the stopper portion 54, the stator housing 56, and the yoke 57 are fixed by an adhesive, so that an annular structure 52 is formed.

The electromagnetic coil 53 includes a first coil portion 53a and a second coil portion 53b. The first and second coil portions 53a and 53b of this embodiment are connected to each other in series. Each of the first and second coil portions 53a and 53b is formed in an annular shape that has a center on the axis of the rotating shaft 2a of the compressor 2.

The first coil portion 53a is disposed on the first side of the permanent magnet 51 in the axial direction. The second coil portion 53b is disposed on the second side of the permanent magnet 51 in the axial direction. That is, the permanent magnet 51 is interposed between the first and second coil portions 53a and 53b.

A coil wire made of copper, aluminum, or the like is wound on a spool, which is molded with, for example, a resin, so as to form multiple lines and multiple layers, so that the first and second coil portions 53a and 53b of this embodiment are formed.

The movable member 55 is disposed outside the electromagnetic coil 53 and the yoke 57 in the radial direction of the rotating shaft 2a. Specifically, the movable member 55 is disposed with a clearance interposed between itself and the electromagnetic coil 53 and the yoke 57.

The movable member 55 is formed in the shape of a cylinder that has a center on the axis of the rotating shaft 2a. The movable member 55 is disposed inside the outer cylindrical portion 31 in the radial direction of the rotating shaft 2a. A clearance M2 is formed between the movable member 55 and the outer cylindrical portion 31. The movable member 55 is adapted to be movable relative to the electromagnetic coil 53 and the yoke 57 in the axial direction of the rotating shaft 2a (a thrust direction). The movable member 55 is made of a magnetic material (for example, iron).

Here, the entire length of the movable member 55 in the rotation axis direction is shorter than the entire length of the structure 52 in the rotation axis direction. Accordingly, when the movable member 55 is positioned at a position on the first side in the axial direction (hereinafter, referred to as a first position), a gap (air gap) is formed on the second side in the axial direction. The gap increases the magnetic resistance of the non-attracting magnetic circuit MCb that is formed on the side opposite to the end face portion 33 of the pulley 30 by the permanent magnet 51.

In contrast, when the movable member 55 is positioned at a position on the second side in the axial direction (referred to as a second position), a gap is formed on the first side in the axial direction. The gap increases the magnetic resistance of the attracting magnetic circuit MCa that is formed on the end face portion 33 of the pulley 30 by the permanent magnet 51.

Each of the magnetic resistance of the attracting magnetic circuit MCa and the magnetic resistance of the non-attracting magnetic circuit MCb can be changed by the movement of the movable member 55 in the axial direction.

The stopper portion 54 is disposed on the first side of the movable member 55 and the first coil portion 53a of the electromagnetic coil 53 in the axial direction. The stopper portion 54 makes the movable member 55 collide with the stopper portion 54 itself to stop the movement of the movable member 55 to the first side in the axial direction.

The stator housing 56 includes a cylinder portion 56a and a wall portion 56b. The cylinder portion 56a is disposed inside the permanent magnet 51 and the electromagnetic coil 53 in the radial direction of the rotating shaft 2a. The cylinder portion 56a is formed in the shape of a cylinder that has a center on the axis of the rotating shaft 2a. The wall portion 56b is formed in an annular shape so as to spread from the second side of the cylinder portion 56a to the outside in the radial direction of the rotating shaft 2a. The cylinder portion 56a and the wall portion 56b are integrally made of a magnetic material (for example, iron), and form the attracting magnetic circuit MCa and the non-attracting magnetic circuit MCb, respectively.

Meanwhile, a through hole 56c through which electric wires 53c connecting the electromagnetic coil 53 to a control unit (first and second control units) 6 pass is formed at the wall portion 56b of the stator housing 56.

The stator housing 56 of this embodiment is fixed to the housing 2c of the compressor 2 by fixing members such as a snap ring 101. The stator housing 56 forms the structure 52 as described above. For this reason, the structure 52 is fixed to the housing 2c of the compressor 2. Further, a clearance M1 is formed between the cylinder portion 56a of the stator housing 56 and the inner cylindrical portion 32 of the pulley 30.

The yoke 57 is disposed between the first and second coil portions 53a and 53b, and is formed in the shape of a ring that has a center on the axis of the rotating shaft 2a. The yoke 57 is integrally made of a magnetic material (for example, iron), and forms the attracting magnetic circuit MCa and the non-attracting magnetic circuit MCb.

Further, the control unit 6 of FIG. 1 controls the supply of power to the first and second electromagnetic coils 53a and 53b on the basis of a control signal that is output from an air conditioner ECU (an electronic control unit).

Next, the operation of the clutch mechanism 20 of this embodiment will be described with reference to FIG. 6. FIG. 6 is a view using the cross-sectional view of a portion B of FIG. 2.

First, when the pulley 30 and the armature 40 are connected to each other as shown in FIG. 6(a), the movable member 55 is positioned at the first position.

In this case, the magnetic resistance of the attracting magnetic circuit MCa, which is formed by the permanent magnet 51, is reduced in comparison with the magnetic resistance of the attracting magnetic circuit that is obtained when the movable member 55 is positioned at the second position. Accordingly, a magnetic force generated by the attracting magnetic circuit MCa increases.

The attracting magnetic circuit MCa is a magnetic circuit in which magnetic flux passes through the yoke 57, the movable member 55, the outer cylindrical portion 31, the end face portion 33, the armature 40, the end face portion 33, the armature 40, the end face portion 33, the armature 40, the end face portion 33, the inner cylindrical portion 32, the cylinder portion 56a of the stator housing 56, and the permanent magnet 51 in this order as shown by the thick solid line of FIG. 6(a).

Specifically, magnetic flux passes between the outer cylindrical portion 31 and the inner cylindrical portion 32 in the attracting magnetic circuit MCa so as to avoid the non-magnetic portions 90 and 91 of the armature 40 and the non-magnetic portions 70, 71, and 72 of the pulley 30.

That is, magnetic flux passes through the ring members 80, 81, and 82 of the armature 40 and the ring members 60, 61, 62, and 63 of the pulley 30 between the outer cylindrical portion 31 and the inner cylindrical portion 32 in the attracting magnetic circuit MCa. For this reason, magnetic flux passes through a boundary between the armature 40 and the pulley 30 six times.

In addition, a magnetic force, which is generated by the attracting magnetic circuit MCa shown by the thick solid line of FIG. 6(a), is magnetic attraction that causes the pulley 30 and the armature 40 to be connected to each other.

Further, when the movable member 55 is positioned at the first position, a gap is formed between the movable member 55 and the wall portion 56b of the stator plate 56.

The gap reduces a magnetic force, which is generated by the non-attracting magnetic circuit MCb, by increasing the magnetic resistance of the non-attracting magnetic circuit MCb. The non-attracting magnetic circuit MCb is a magnetic circuit that is formed by the permanent magnet 51 and is different from the attracting magnetic circuit MCa. The non-attracting magnetic circuit MCb is a magnetic circuit in which magnetic flux passes through the yoke 57, the movable member 55, the stator plate 56, and the permanent magnet 51 in this order as shown by the thin broken line of FIG. 6(a). A magnetic force, which is generated by the non-attracting magnetic circuit MCb, does not function as attraction that connects the pulley 30 to the armature 40.

In addition, when the movable member 55 is positioned at the first position, the amount of magnetic flux of the attracting magnetic circuit MCa increases in comparison with the amount of magnetic flux of the attracting magnetic circuit that is obtained when the movable member 55 is positioned at the second position. Accordingly, the movable member 55 is kept at the first position.

Further, in this embodiment, the elastic force of the leaf spring 45 is set to be smaller than the magnetic attraction that is generated in the attracting magnetic circuit MCa when the movable member 55 is positioned at the first position. Accordingly, even though power is not supplied to the electromagnetic coil 53, a state in which the pulley 30 and the armature 40 are connected to each other is maintained. That is, the rotational drive force applied from the engine 10 is transmitted to the compressor 2.

Next, the control unit 6 starts to supply power to the electromagnetic coil 53 in a first direction. At this time, a current flows in the first coil 53a to the front of the plane of paper from the back of the plane of paper and a current flows in the second coil 53b to the front of the plane of paper from the back of the plane of paper as shown in FIG. 6(b). For this reason, the first coil 53a reduces the amount of magnetic flux passing through the attracting magnetic circuit MCa, and the second coil 53b increases the amount of magnetic flux passing through the non-attracting magnetic circuit MCb. Accordingly, the magnetic force, which is generated by the non-attracting magnetic circuit MCb shown by the thick broken line of FIG. 6(b), becomes larger than the magnetic attraction that is generated by the attracting magnetic circuit MCa shown by the thin solid line of FIG. 6(b).

As a result, the movable member 55 is moved to the second position from the first position by the magnetic force that is generated by the non-attracting magnetic circuit MCb. That is, the movable member 55 is moved to the second position from the first position by a magnetic force that is generated from the permanent magnet 51 and an electromagnetic force that is generated from the second coil 53b. After that, the control unit 6 ends the supply of power to the electromagnetic coil 53.

The magnetic resistance of the non-attracting magnetic circuit MCb is reduced with the movement of the movable member 55, so that the amount of magnetic flux passing through the non-attracting magnetic circuit MCb increases. For this reason, the movable member 55 is kept at the second position as shown in FIG. 6(c).

Here, when the movable member 55 is positioned at the second position, a gap is formed between the movable member 55 and the end face portion 33 of the pulley 30. The magnetic resistance of the attracting magnetic circuit MCa is increased by the gap in comparison with the magnetic resistance of the attracting magnetic circuit that is obtained when the pulley 30 and the armature 40 are connected to each other. For this reason, the magnetic attraction generated from the attracting magnetic circuit MCa is reduced. As a result, the elastic force of the leaf spring 45 becomes larger than the magnetic attraction. For this reason, even though power is not supplied to the electromagnetic coil 53, a state in which the pulley 30 and the armature 40 are separated from each other is maintained by the elastic force of the leaf spring 45. Accordingly, the rotational drive force applied from the engine 10 is not transmitted to the compressor 2.

Next, the control unit 6 starts to supply power to the electromagnetic coil 53 in a second direction. The second direction is a direction that is opposite to the first direction. For this reason, a current flows in the first coil portion 53a to the back of the plane of paper from the front of the plane of paper and a current flows in the second coil portion 53b to the back of the plane of paper from the front of the plane of paper as shown in FIG. 6(d). Accordingly, the first coil portion 53a increases the amount of magnetic flux passing through the attracting magnetic circuit MCa, and the second coil portion 53b generates an electromagnetic force that reduces the amount of magnetic flux passing through the non-attracting magnetic circuit MCb. As a result, the magnetic attraction, which is generated by the attracting magnetic circuit MCa, becomes larger than the magnetic force that is generated by the non-attracting magnetic circuit MCb.

As a result, the movable member 55 is moved to the first position from the second position by the magnetic attraction that is generated by the attracting magnetic circuit MCa. That is, the movable member 55 is moved to the first position from the second position by a magnetic force that is generated from the permanent magnet 51 and an electromagnetic force that is generated from the first coil 53a. That is, the movable member 55 returns to a state shown in FIG. 6(a). After that, the control unit 6 ends the supply of power to the electromagnetic coil 53.

The magnetic resistance of the attracting magnetic circuit MCa is reduced with the movement of the movable member 55, so that the amount of magnetic flux of the attracting magnetic circuit MCa increases. As a result, since the magnetic attraction becomes larger than the elastic force of the leaf spring 45, the pulley 30 and the armature 40 are connected to each other. That is, the rotational drive force applied from the engine 10 is transmitted to the compressor 2.

According to this embodiment that has been described above, when the pulley 30 and the armature 40 are connected to each other, the movable member 55 is positioned at the first position where the magnetic resistance of the attracting magnetic circuit MCa is smaller than the magnetic resistance of the attracting magnetic circuit that is obtained when the pulley 30 and the armature 40 are separated from each other. When the pulley 30 and the armature 40 are separated from each other, the movable member 55 is positioned at the second position where the magnetic resistance of the non-attracting magnetic circuit MCb is smaller than the magnetic resistance of the non-attracting magnetic circuit that is obtained when the pulley 30 and the armature 40 are connected to each other. The control unit 6 supplies power to the electromagnetic coil 53 so that the magnetic force generated from the attracting magnetic circuit MCa is larger than the magnetic force generated from the non-attracting magnetic circuit MCb. Accordingly, the movable member 55 is displaced to the first position from the second position by the magnetic force that is generated from the attracting magnetic circuit MCa. The control unit 6 supplies power to the electromagnetic coil 53 so that the magnetic force generated from the non-attracting magnetic circuit MCb is larger than the magnetic force generated from the attracting magnetic circuit MCa. Accordingly, the movable member 55 is displaced to the second position from the first position by the magnetic force that is generated from the non-attracting magnetic circuit MCb.

Here, the non-magnetic portions 90 and 91 of the armature 40 and the non-magnetic portions 70, 71, and 72 of the pulley 30 are offset from one another in the radial direction of the rotating shaft 2a. For this reason, magnetic flux passes between the outer cylindrical portion 31 and the inner cylindrical portion 32 in the attracting magnetic circuit MCa so as to avoid the non-magnetic portions 90 and 91 of the armature 40 and the non-magnetic portions 70, 71, and 72 of the pulley 30. Accordingly, magnetic flux passes through the boundary between the armature 40 and the pulley 30 six times.

Here, the number of poles is defined as the number of times in which the magnetic flux passing through the attracting magnetic circuit MCa passes through the boundary between the pulley 30 and the armature 40. Further, planes in which the magnetic flux passing through the attracting magnetic circuit MCa passes through the boundary between the pulley 30 and the armature 40 are defined as poles. According to this definition, the number of poles of the attracting magnetic circuit MCa of this embodiment is six.

Furthermore, when the non-magnetic portions of the armature 40 and the non-magnetic portions of the pulley 30 are configured as in a second embodiment that will be described below, magnetic flux passes through the boundary between the armature 40 and the pulley 30 eight times. Accordingly, the number of poles of the attracting magnetic circuit MCa is eight.

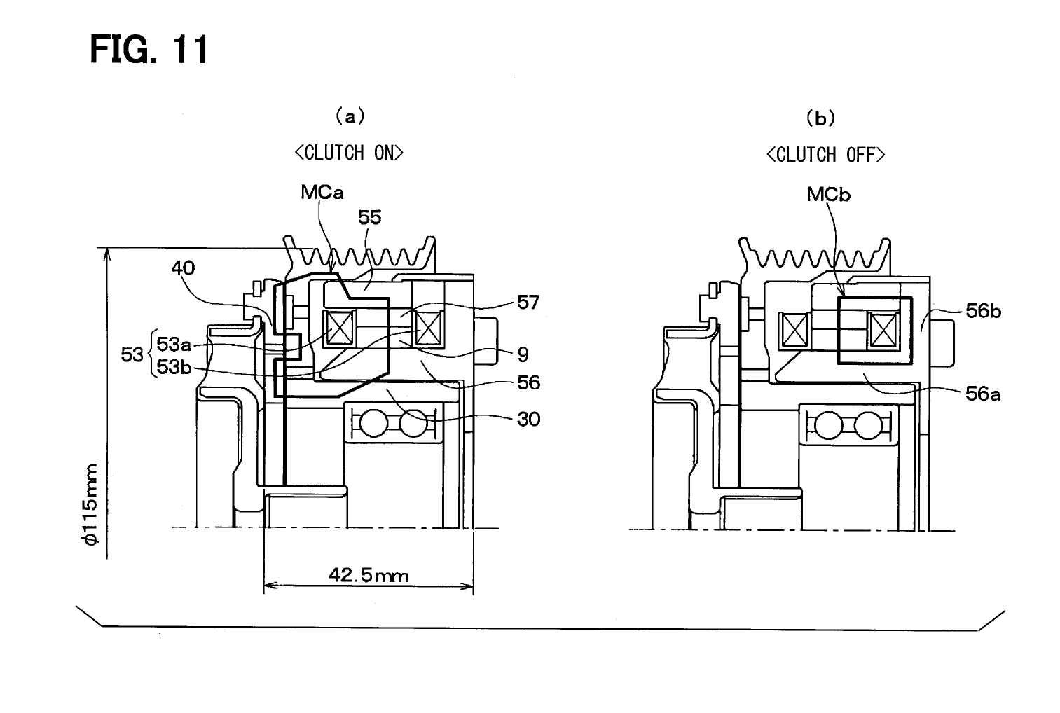

Meanwhile, the number of poles of an attracting magnetic circuit MCa of a clutch mechanism shown in FIG. 11 is four. For this reason, the number of poles of the attracting magnetic circuit MCa of each of the first and second embodiments is larger than the number of poles of the attracting magnetic circuit MCa of the clutch mechanism shown in FIG. 11.

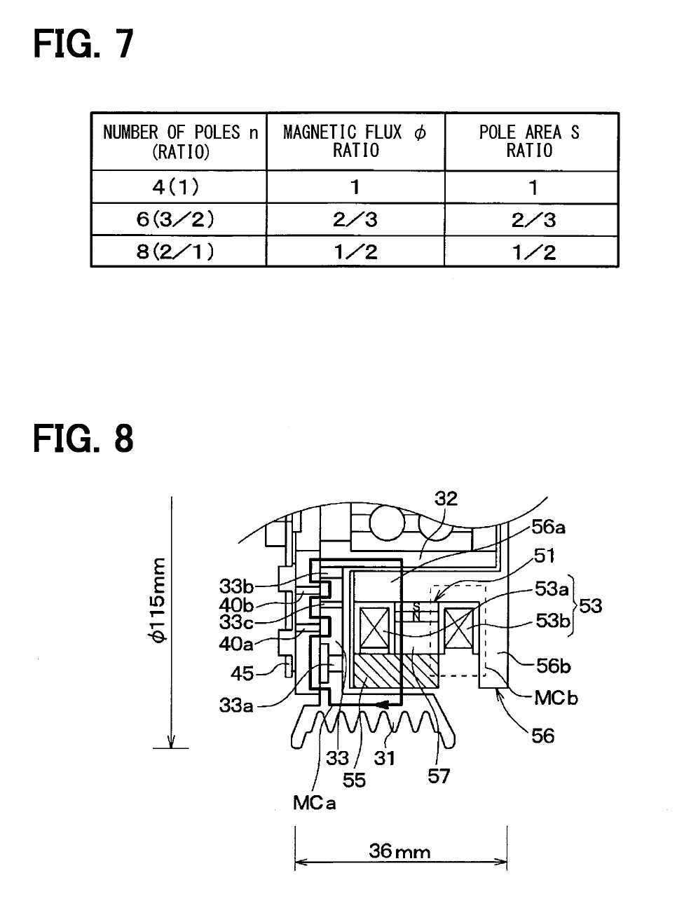

A table of FIG. 7 shows conditions that are necessary to obtain the same attraction, that is, the same torque when the number of poles of the attracting magnetic circuit MCa is set to 4, 6, and 8. However, the inner and outer diameters (that is, the inner diameter and the outer diameter) of the friction surface between the armature 40 and the pulley 30 are the same in all cases in which the number of poles is 4, 6, and 8.

The table of FIG. 7 is based on the following equations 1 and 2.

$$\begin{matrix}T = μ \cdot F \cdot R & [ Equation 1 ] \\ F ∝ n \cdot \frac{{φ}^{2}}{2 \cdot {μ}_{0} \cdot S} & [ Equation 2 ]\end{matrix}$$

Transmission torque T is represented by the product of a coefficient μ of friction, the attraction F of the friction surface, and a mean effective radius R of the friction surface. The attraction F is represented by the number of poles n, the amount of magnetic flux Φ, vacuum magnetic permeability μ0, and a pole area S.

Here, the mean effective radius R of the friction surface is the radius of the friction surface between the armature 40 and the pulley 30. The transmission torque T is transmission torque that is transmitted between the armature 40 and the pulley 30. μ denotes the coefficient of friction of the friction surface between the armature 40 and the pulley 30. F denotes the attraction between the armature 40 and the pulley 30. R denotes the mean effective radius of the friction surface. n denotes the number of poles, Φ denotes the amount of magnetic flux flowing in the attracting magnetic circuit MCa, and μ0 denotes vacuum magnetic permeability. S denotes a pole area. In this embodiment, the pole area is defined as the area of one of multiple poles.

Here, when a pole area in a case in which the number of poles is 4 is denoted by S4 and a pole area in a case in which the number of poles is n (≧6) is denoted by Sn, the inner and outer diameters of the friction surface between the armature 40 and the pulley 30 are same in all cases in which the number of poles is 4 and n (≧6) as described above. For this reason, a ratio of S4 to S6 is 1:2/3, and a ratio of S4 to S8 is 1:1/2. Further, when the density of magnetic flux passing through each pole in which the number of poles is 4 is the same as that in which the number of poles is n, a ratio of the amount of magnetic flux Φ passing through each pole is the same as a ratio of the pole area S. Furthermore, a ratio of Φ4 to Φ6 is 1:2/3, and a ratio of Φ4 to Φ8 is 1:1/2. The amount of magnetic flux in a case in which the number of poles is n (≧4) is denoted by Φn.

If the number of poles is large when the attracting magnetic circuit MCa of this embodiment and the attracting magnetic circuit MCa shown in FIG. 11 are to generate the same magnetic attraction, magnetic flux flowing in the attracting magnetic circuit MCa is reduced. Accordingly, the amount of the permanent magnet 51 to be used is reduced. That is, the physical size of the permanent magnet 51 can be reduced. For this reason, the physical size of the clutch mechanism 20 can be reduced.

FIG. 8 shows an example of the dimensions of the clutch mechanism 20 of this embodiment. The area of the outer peripheral surface of the permanent magnet 51 of FIG. 8 (=outer peripheral length×axial length) can be set to ⅔ of the area of the outer peripheral surface of a permanent magnet 51 of FIG. 11. In addition, the amount of magnetic flux flowing in the attracting magnetic circuit MCa is ⅔. For this reason, since a magnetic flux density (the amount of magnetic flux per unit area) is the same as the magnetic flux density of the attracting magnetic circuit of FIG. 11 even though the cross-sectional area of a passage of the attracting magnetic circuit MCa through which magnetic flux passes is set to ⅔, magnetic saturation is not caused. Accordingly, the thickness (the dimension in a direction perpendicular to the flow direction of magnetic flux) of each of the pulley 30, the stator 50, and the movable member 32 can be set to ⅔.

Due to the above-mentioned effects, the cross-sectional areas of the first and second coil portions 53a and 53b can be increased and the axial length (the dimension in the axial direction) of the clutch mechanism 20 can be reduced.

In addition, since the magnetic flux flowing in the attracting magnetic circuit MCa is reduced as described above, a magnetomotive force of the electromagnetic coil 53, which is necessary to change the state of the clutch mechanism 20 into an ON state from an OFF state, can also be reduced. The magnetomotive force, which is 700 AT in FIG. 11, is changed to 466 AT that is ⅔ of 700 AT (=700 AT×2/3) in FIG. 7.

Moreover, since the cross-sectional areas of the first and second coil portions 53a and 53b can be increased as described above, a coil wire having a small cross-sectional area can be wound multiple times. That is, when a desired magnetomotive force of 466 AT is to be generated and the cross-sectional areas of the first and second coil portions 53a and 53b are large, the diameter of the coil wire forming the first and second coil portions 53a and 53b can be reduced and the number of times of winding the coil wire can be increased.

Here, since the resistance value of the coil wire per unit cross-sectional area is increased as the diameter of the coil wire is reduced, a current flowing in the first and second coil portions 53a and 53b is reduced. For this reason, the power consumption of the electromagnetic coil 53 is reduced as the cross-sectional areas of the first and second coil portions 53a and 53b are increased.

As described above, the power consumption of the electromagnetic coil 53 can be significantly reduced through the reduction of the magnetomotive force of the electromagnetic coil 53 and the increase of the cross-sectional areas of the first and second coil portions 53a and 53b.

Specifically, the power consumption of the electromagnetic coil 53, which is necessary to change the state of the clutch mechanism 20 into an ON state from an OFF state, is proportional to the square of the magnetomotive force and is inversely proportional to the cross-sectional areas of the first and second coil portions 53a and 53b. For example, since the power consumption of the electromagnetic coil 53, which was 120 W in FIG. 11, is 35.6 W that is the product of 120 W and (2/3)²×(1/1.5) in FIG. 7, power consumption can be significantly reduced.

Here, the OFF state of the clutch mechanism 20 is a state in which the pulley 30 and the armature 40 are separated from each other. The ON state of the clutch mechanism is a state in which the pulley 30 and the armature 40 are connected to each other.

Since the same transmission torque as in the related art is achieved as described above with a small amount of the permanent magnet 51 to be used, the physical size of the clutch mechanism 20 can be reduced and the power consumption of the electromagnetic coil 53 can also be reduced.

### Second Embodiment

An example in which the number of poles of the attracting magnetic circuit MCa is made to be 6 by the non-magnetic portions 90 and 91 of the armature 40 and the non-magnetic portions 70, 71, and 72 of the pulley 30 has been described in the first embodiment. However, instead of this example, an example in which an armature 40 and a pulley 30 are formed so that the number of poles of an attracting magnetic circuit MCa is 8 will be described in this embodiment.

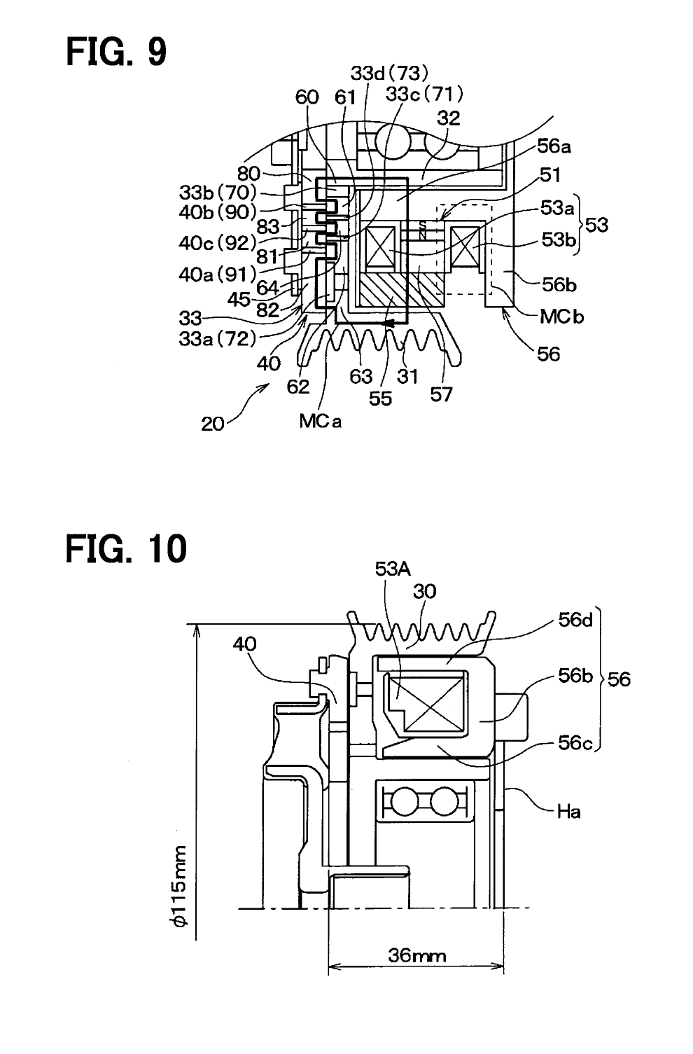

FIG. 9 is a partial cross-sectional view of a clutch mechanism 20 of this embodiment. FIG. 9 is a view corresponding to the portion B of FIG. 2.

The armature 40 of this embodiment is obtained by adding a ring member 83 and a non-magnetic portion 92 (a driven-side non-magnetic portion) to the armature 40 of the first embodiment. For this reason, the armature 40 of this embodiment includes the ring members 80, 81, 82, and 83 and the non-magnetic portions 90, 91, and 92. The ring member 83 is made of a magnetic material, and is formed in the shape of a ring that has a center on the axis of the rotating shaft 2a. The ring member 83 is disposed between the ring members 80 and 81. For this reason, the non-magnetic portion 90 of this embodiment is disposed between the ring members 80 and 81. The non-magnetic portion 92 is formed in the shape of a ring that has a center on the axis of the rotating shaft 2a. The non-magnetic portion 92 includes four gaps 40c and four bridge members. In FIG. 9, only one gap 40c is shown and the four bridge members are not shown.

The pulley 30 of this embodiment is obtained by adding a ring member 64 and a non-magnetic portion 73 (a driving-side non-magnetic portion) to the pulley 30 of the first embodiment. The ring member 64 is made of a magnetic material, and is formed in the shape of a ring that has a center on the axis of the rotating shaft 2a. For this reason, the non-magnetic portion 71 of this embodiment is disposed between the ring members 62 and 64. The non-magnetic portion 73 is formed in the shape of a ring that has a center on the axis of the rotating shaft 2a. The non-magnetic portion 73 is disposed between the ring members 61 and 64. The non-magnetic portion 73 includes six gaps 33d and six bridge members (not shown). In FIG. 9, only one gap 33d is shown and the six bridge members are not shown.

In the clutch mechanism 20 of this embodiment that is formed as described above, magnetic flux passes between the outer cylindrical portion 31 and the inner cylindrical portion 32 in the attracting magnetic circuit MCa so as to avoid the non-magnetic portions 90, 91, and 92 of the armature 40 and the non-magnetic portions 70, 71, 72, and 73 of the pulley 30.

That is, magnetic flux passes through the ring members 80, 81, 82, and 83 of the armature 40 and the ring members 60, 61, 62, 63, and 64 of the pulley 30 between the outer cylindrical portion 31 and the inner cylindrical portion 32 in the attracting magnetic circuit MCa. For this reason, magnetic flux passes through a boundary between the armature 40 and the pulley 30 eight times. Accordingly, the number of poles of the attracting magnetic circuit MCa of this embodiment is eight.

According to this embodiment that has been described above, the number of poles of the attracting magnetic circuit MCa of this embodiment is larger than the number of poles of the attracting magnetic circuit MCa of the first embodiment. Accordingly, when the attracting magnetic circuit MCa of this embodiment and the attracting magnetic circuit MCa of the first embodiment generate the same magnetic attraction, magnetic flux flowing in the attracting magnetic circuit MCa in this embodiment is smaller than that in the first embodiment. For this reason, the amount of the permanent magnet 51 to be used can be reduced in comparison with that in the first embodiment. That is, the physical size of the permanent magnet 51 can be reduced in comparison with that in the first embodiment. For this reason, the physical size of the clutch mechanism 20 can be reduced.

In addition, since the physical size of the permanent magnet 51 can be reduced, the magnetomotive force of the electromagnetic coil 53 can be reduced and the cross-sectional areas of the first and second coil portions 53a and 53b can be increased. Accordingly, the power consumption of the electromagnetic coil 53 can be reduced in comparison with that in the first embodiment.

### Other Embodiments

An example in which the armature 40 and the pulley 30 are formed so that the number of poles of the attracting magnetic circuit MCa is six has been described in the first embodiment. Further, an example in which the armature 40 and the pulley 30 are formed so that the number of poles of the attracting magnetic circuit MCa is eight has been described in the second embodiment. However, the invention is not limited thereto, and the armature 40 and the pulley 30 may be formed so that the number of poles of the attracting magnetic circuit MCa is ten or more.

That is, the clutch mechanism 20 of which the number of poles of the attracting magnetic circuit MCa is ten or more can be employed in a case of the clutch mechanism 20 of which the number of poles of the attracting magnetic circuit MCa is six or more.

Meanwhile, in order to implement the clutch mechanism 20 of which the number of poles is ten or more, the number of the non-magnetic portions of the armature 40 and the number of the non-magnetic portions of the pulley 30 can be increased in comparison with a case in which the number of poles is eight.

Examples in which six bridge members are provided on each non-magnetic portion at the end face portion 33 of the pulley 30 have been described in the first and second embodiments. However, the invention is not limited thereto, and seven or more bridge members may be provided on each non-magnetic portion. Alternatively, the number of the bridge members provided on each non-magnetic portion may be in the range of 1 to 5.

Examples in which four bridge members are provided on each non-magnetic portion at the armature 40 have been described in the first and second embodiments. However, the invention is not limited thereto, and five or more bridge members may be provided on each non-magnetic portion. Alternatively, the number of the bridge members provided on each non-magnetic portion may be in the range of 1 to 3.

Examples in which a non-magnetic metal (that is, bridge members) and gaps form each non-magnetic portion at the end face portion 33 of the pulley 30 have been described in the first and second embodiments. However, the invention is not limited thereto, and each non-magnetic portion may be made of only a non-magnetic metal. Further, a non-magnetic material such as a resin may be used instead of the gap.

Examples in which a non-magnetic metal and gaps form each non-magnetic portion at the armature 40 have been described in the first and second embodiments. However, the invention is not limited thereto, and each non-magnetic portion may be made of only a non-magnetic metal. Further, a non-magnetic material such as a resin may be used instead of the gap.

Examples in which the clutch mechanism 20 is formed so as to move the movable member 55 in the axial direction of the rotating shaft 2c by the supply of power to the electromagnetic coil 53 have been described in the first and second embodiments. However, the invention is not limited thereto, and a direction in which the movable member 55 is moved by the supply of power to the electromagnetic coil 53 may be set to directions other than the axial direction of the rotating shaft 2c in the clutch mechanism 20.

A clutch mechanism, which intermittently transmits a rotational drive force to the compressor 2 from the engine 10, has been described as the clutch mechanism 20 in the first and second embodiments. However, this disclosure is not limited thereto, and may be applied to any one of clutch mechanisms that intermittently transmits a rotational drive force to a second device from a first device.

Examples in which the outer peripheral portion of the permanent magnet 51 forms an N pole and the inner peripheral portion of the permanent magnet 51 forms an S pole have been described in the first and second embodiments. However, the outer peripheral portion of the permanent magnet 51 may form an S pole and the inner peripheral portion of the permanent magnet 51 may form an N pole instead.

Meanwhile, the present disclosure is not limited to the above-mentioned embodiments, and may be appropriately modified. Further, in each of the above-mentioned embodiments, it goes without saying that components of the embodiment are not necessarily essential except for a case in which the components are particularly clearly specified as essential components, a case in which the components are clearly considered in principle as essential components, and the like. Furthermore, when the number of components of the embodiment, dimensions, the amount, and numerical values of the ranges and the like are mentioned in each of the above-mentioned embodiments, the number of components of the embodiment, dimensions, the amount, and numerical values of the ranges and the like are not limited to specific numerals except for a case in which the numerals are particularly clearly specified as essential values, a case in which the numerals are limited to specific numerals in principle, and the like.

What is claimed is:

1. A clutch mechanism comprising:
a driving-side rotating body that is rotated by a rotational drive force from a drive source;
a driven-side rotating body, to which the rotational drive force is transmitted, that is connected to the driving-side rotating body;
a permanent magnet that forms, together with the driving-side rotating body and the driven-side rotating body, an attracting magnetic circuit which generates magnetic attraction that causes the driving-side rotating body and the driven-side rotating body to be connected to each other, the permanent magnet forming a non-attracting magnetic circuit different from the attracting magnetic circuit;
an electromagnetic coil that generates an electromagnetic force that changes a magnetic force generated from the attracting magnetic circuit and a magnetic force generated from the non-attracting magnetic circuit;
a movable member that is made of a magnetic material and is displaceable, the movable member positioning at a first position where a magnetic resistance of the attracting magnetic circuit is smaller when the driving-side rotating body and the driven-side rotating body are connected to each other than when the driving-side rotating body and the driven-side rotating body are separated from each other, the movable member positioning at a second position where the magnetic resistance of the non-attracting magnetic circuit is smaller when the driving-side rotating body and the driven-side rotating body are separated from each other than when the driving-side rotating body and the driven-side rotating body are connected from each other;
a first control unit that displaces the movable member, to a side of the first position from a side of the second position using the magnetic force generated from the attracting magnetic circuit, by supplying power to the electromagnetic coil so that the magnetic force generated from the attracting magnetic circuit is larger than the magnetic force generated from the non-attracting magnetic circuit; and
a second control unit that displaces the movable member, to the side of the second position from the side of the first position using the magnetic force generated from the non-attracting magnetic circuit, by supplying power to the electromagnetic coil so that the magnetic force generated from the non-attracting magnetic circuit is larger than the magnetic force generated from the attracting magnetic circuit, wherein
a number of poles is defined as a number of times a magnetic flux flowing through the attracting magnetic circuit passes through a boundary between the driving-side rotating body and the driven-side rotating body, and
the driving-side rotating body and the driven-side rotating body are configured so that the number of poles of the attracting magnetic circuit is six or more.

2. The clutch mechanism according to claim 1, wherein
the driving-side rotating body is made of a non-magnetic material, is formed in an annular shape having a center on an axis of the driving-side rotating body, and includes a plurality of driving-side non-magnetic portions disposed offset from one another in a radial direction,
the driven-side rotating body is made of a non-magnetic material, is formed in an annular shape having a center on an axis of the driving-side rotating body, and includes a plurality of driven-side non-magnetic portions disposed offset from one another in the radial direction, and
the plurality of driving-side non-magnetic portions and the plurality of driven-side non-magnetic portions are configured so that the magnetic flux passes through a region of the driving-side rotating body except for the plurality of driving-side non-magnetic portions and a region of the driven-side rotating body except for the plurality of driven-side non-magnetic portions and the number of poles of the attracting magnetic circuit is six or more.

3. The clutch mechanism according to claim 2, wherein
the driving-side rotating body includes
an outer cylindrical portion that is formed in a cylindrical shape having a center line on the axis of the driving-side rotating body,
an inner cylindrical portion that is disposed inside the outer cylindrical portion in a radial direction having a center line on the axis, the inner cylindrical portion being formed in a cylindrical shape having a center line on the axis, and
an end face portion that is formed to span between the outer cylindrical portion and the inner cylindrical portion.

4. The clutch mechanism according to claim 3, wherein
the plurality of driving-side non-magnetic portions are provided on the end face portion, and
the end face portion is disposed to face the plurality of driven-side non-magnetic portions.

5. The clutch mechanism according to claim 4, wherein
the electromagnetic coil includes a first coil portion that increases and decreases the magnetic force generated from the attracting magnetic circuit, and a second coil portion that increases and decreases the magnetic force generated from the non-attracting magnetic circuit.
